(19) United States
(12) Patent Application Publication
(10) Pub. No.: US 2005/0263528 A1
(43) Pub. Date: Dec. 1, 2005

(54) Climate controlled dry goods storage

(75) Inventors: John Maldonado, Katy, TX (US); Lawrence D. Baab, Houston, TX (US)

Correspondence Address: NIXON & VANDERHYE, PC, 901 NORTH GLEBE ROAD, 11TH FLOOR, ARLINGTON, VA, 22203, US

(73) Assignee: IGLOO PRODUCTS CORPORATION, Houston, TX (US)

(21) Appl. No.: 10/855,628

(22) Filed: May 28, 2004

(51) Int. Cl. B67D 5/62

(52) U.S. Cl. 220/592.2

(57) ABSTRACT

An auxiliary accessory or dry goods storage compartment is provided in or on a top or side wall of a cooler. The interior of the auxiliary compartment is in communication with the chilled conditions of the main compartment of the cooler. In an exemplary embodiment the dry goods storage compartment can be independently accessed through it's own lid or access door so as not to compromise the reduced temperature of the main compartment.

### BACKGROUND AND SUMMARY OF THE INVENTION

Insulated coolers or ice chests are conventionally used to transport beverages and food to the beach, to sporting events and on picnics. Typically the coolers are filled with chilled beverages and the like and ice is added to keep the food and beverages cool, aided by the insulated walls of the ice chest. Often times it is desirable to keep other products, e.g. dry goods that would be adversely affected on contact with ice or water, cool. For example, sandwiches, candy bars and the like are advantageously shielded from ambient heat and more preferably cooled, but it is undesirable for such products to be put directly in the ice chest as they may be crushed by heavier articles or will become damp on contact with the melting ice.

Conventionally trays have been included in larger ice chests in which dry goods can be placed to suspend them above the ice and heavier articles in the bottom of an ice chest. However, such trays can be cumbersome and can block access to the beverages and other articles below them. Also, when accessing the dry goods tray, the entire interior of the ice chest is exposed to ambient temperatures, thereby losing much of the retained cold.

It would therefore be desirable to provide a separately accessible compartment that is effectively separate from the main compartment of the cooler but which is communicated with the main compartment of the cooler to maintain the contents thereof cool. In this manner, accommodation can be made for dry goods requiring climate control, but because the compartments are separately accessible, the contents can be retrieved without compromising the temperature of the entire main compartment.

The invention provides a secondary or auxiliary accessory or dry goods storage compartment which is in communication with the chilled conditions of the main compartment of the ice chest or cooler (herinafter generically “cooler”). In an exemplary embodiment the dry goods storage compartment can be independently accessed so as not to compromise the reduced temperature of the main compartment. The dry goods compartment may be disposed, e.g., in or on the cooler lid, above the main compartment, so as to be well removed from moisture within the main compartment.

Thus, the invention may be embodied in an insulated cooler comprising: a plurality of insulating side wall panels, a bottom wall panel and a lid panel, said wall panels defining together with said lid panel an insulated main compartment; an auxiliary storage compartment provided in or on one of said lid and side wall panels, said auxiliary compartment including an outer peripheral wall and an inner wall that is common with said respective one of said lid and side wall panels, wherein at least a portion of said inner wall has at least one hole defined therethrough to allow air to flow between said main compartment and an interior of said auxiliary compartment while preventing the contents of the auxiliary compartment from entering the main compartment, and at least one access door for selectively accessing said auxiliary compartment remote from said main compartment.

The invention may also be embodied in a soft-side cooler comprising: a plurality of insulating side wall panels, a bottom wall panel and a lid panel, said wall panels defining together with said lid panel an insulated main compartment; an auxiliary storage compartment provided in or on one of said lid and side wall panels, said auxiliary compartment including an outer peripheral wall and an inner wall that is common with said respective one of said lid and side wall panels, wherein at least a portion of said inner wall has at least one hole defined therethrough to allow air to flow between said main compartment and an interior of said auxiliary compartment while preventing the contents of the auxiliary compartment from entering the main compartment, and wherein said side walls are flexible, insulated walls comprising a flexible liner layer, a flexible outer layer, and an insulation layer therebetween.

The accessory compartment may advantageously be used to receive food such as sandwiches and candy bars to keep them at a temperature below ambient temperature while limiting the risk that they will become wet or be crushed by heavier materials within the cooler, such as ice and beverage containers. The dry goods storage compartment provided in accordance with the invention may also be used to store medications such as insulin or anaphylactic shock kits which may be required by the customer on an extended outing and which are preferably maintained in a climate controlled atmosphere.

### BRIEF DESCRIPTION OF THE DRAWINGS

These and other objects and advantages of this invention will be more completely understood and appreciated by careful study of the following more detailed description of the presently preferred exemplary embodiments of the invention taken in conjunction with the accompanying drawings, in which:

FIG. 1 is a perspective view from the front, side and above of a cooler providing climate control dry goods storage according to an embodiment of the invention;

FIG. 2 is a view similar to the view of FIG. 1 showing the secondary lid of a top dry goods storage compartment opened to reveal its interior;

FIG. 3 is a view similar to FIG. 1 showing the main lid of the cooler pivoted to an open position;

FIG. 4 is a perspective view of the cooler interior from behind with the lid fully open, showing a wall between the main cooler and a front compartment in accordance with an embodiment of the invention; and

FIG. 5 is a perspective view of the cooler front showing a cup holder and pivoting lid in an embodiment of the invention, with the pivoting lid in a closed position.

### DETAILED DESCRIPTION OF THE INVENTION

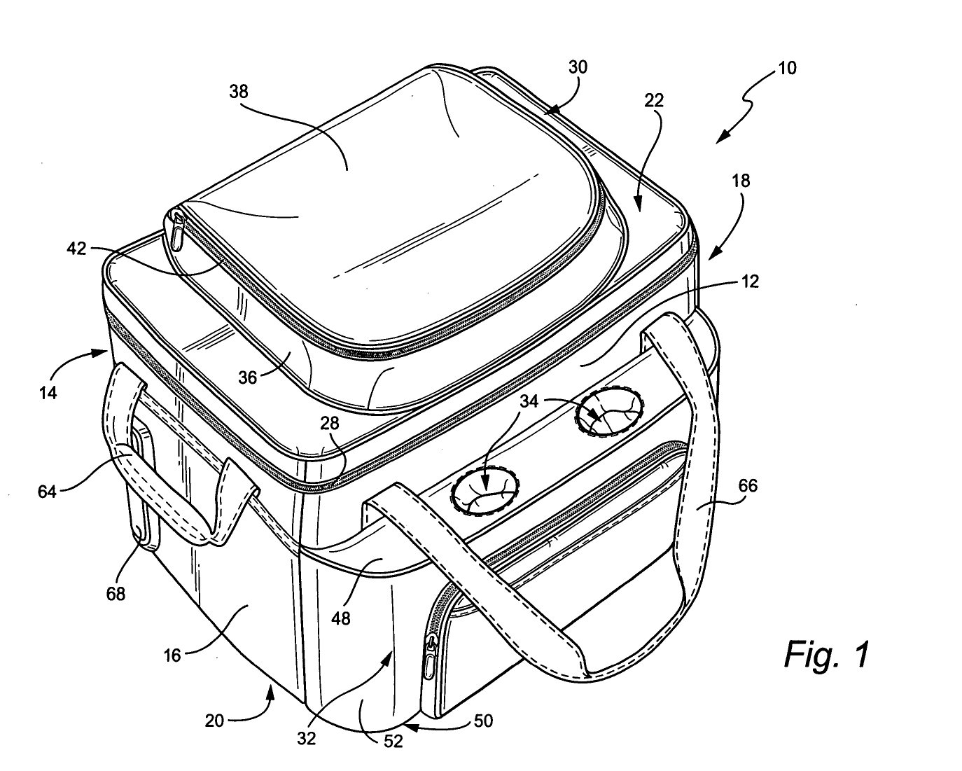

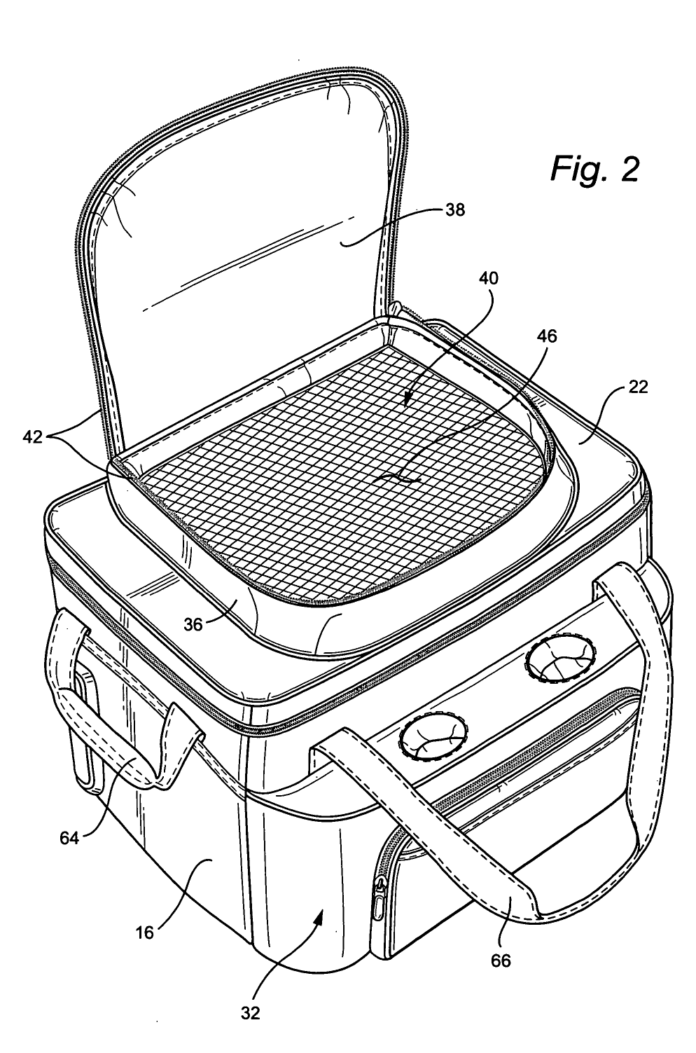

An insulated cooler or ice chest (hereinafter generically referred to as “cooler”) having climate controlled dry goods storage compartments in accordance with exemplary embodiments of the invention is illustrated by way of example in FIGS. 1-3.

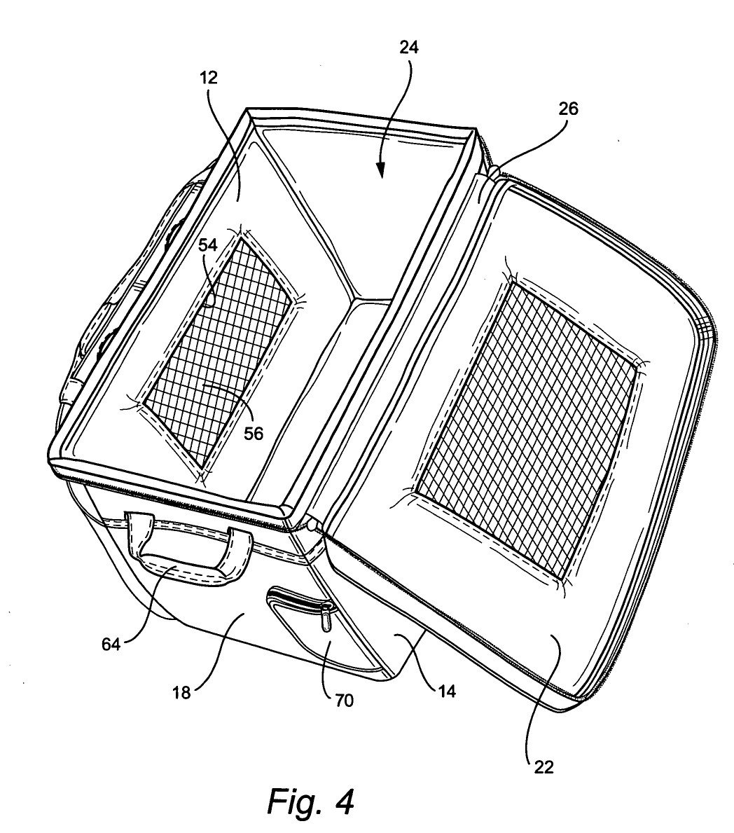

The illustrated cooler 10 includes a plurality of insulating side wall panels 12, 14, 16, 18 and a bottom wall panel 20 which define, together with lid panel 22, an insulated, main compartment 24. For convenience, the side wall panels may be referred to as front 12, rear 14, right 16, and left 18 side walls although such descriptors should not be considered limiting of the configuration of a cooler embodying the invention. In the illustrated embodiment, the cooler is provided as a so-called soft-sided cooler comprised of flexible insulating walls that are formed from a flexible liner layer, a flexible, decorative cover layer and a generally flexible insulating material therebetween. Thus, in the illustrated embodiment the lid 22 is hingedly secured to the rear wall 14 of the cooler, e.g., with a hinge panel 26 (FIG. 4) and may be selectively secured to the right 16, left 18, and front 12 walls with a suitable fastener 28 such as a zipper. In the alternative, the lid may include front and/or right and left flaps that may be detachably secured to the respective side walls of the cooler with snaps, Velcro-type fasteners or the like.

In the illustrated example, an auxiliary, dry goods storage compartment 30 is provided in or on the lid of the cooler and another dry good storage compartment 32 is provided in or on the front side wall of the cooler 10. The side wall storage compartment may of course be provided on e.g., a right or left side wall of the cooler and may omit the beverage container openings 34 of the illustrated embodiment (discussed in greater detail below).

Referring more specifically to the dry goods storage compartment 30 defined in and on the lid of the cooler, the lid compartment is comprised of a peripheral wall 36, an outer wall that in the illustrated embodiment comprises a secondary lid 38 that permits the user to selectively access the interior 40 of the compartment 30 without opening the lid 22 of the main compartment 24. This minimizes any compromise of the cooled air contained within the main compartment 24. As mentioned above, the illustrated embodiment is a soft-sided container, so that the secondary lid 38 is secured by a suitable mechanical fastener 42, such as a zipper, to the peripheral wall 36. In the alternative, the invention may be embodied in a so-called hard-side or rigid walled cooler in which case the main and secondary lids 22, 38 may be each detachably secured in their closed positions by complimentary protrusions and/or recesses, as are conventionally provided for lids of hard sided coolers.

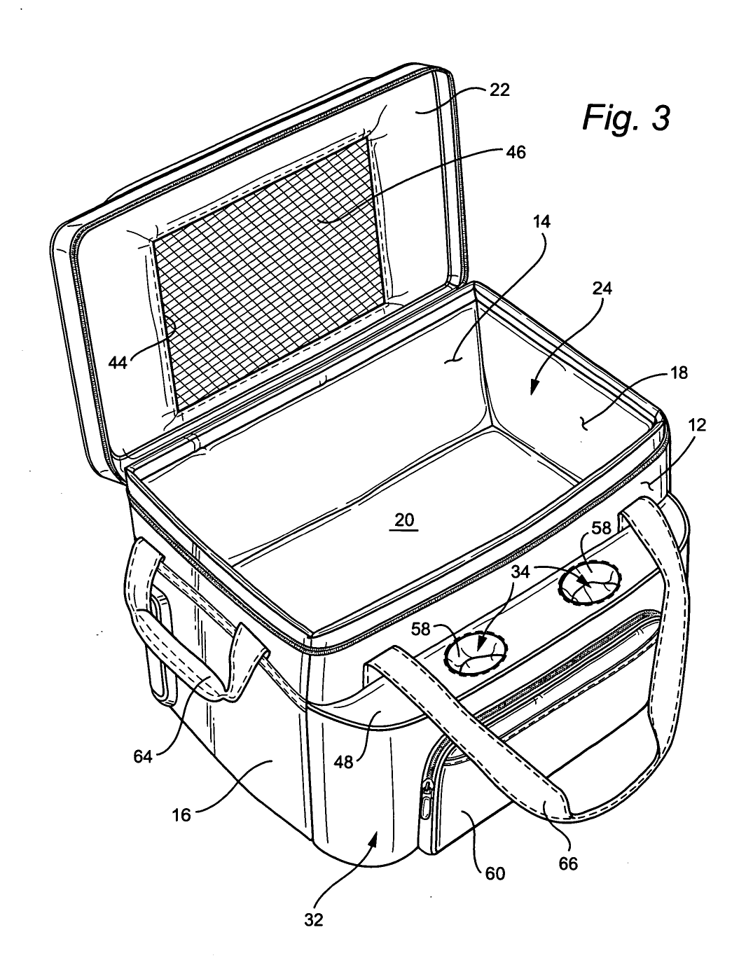

As best illustrated in FIG. 3, an opening 44 is defined between the main compartment 24 and the interior 40 of the lid compartment 30 so that the cooler air within the main compartment 24 can circulate also into the lid compartment. This opening is closed with a wall 46 that is perforated sufficiently to allow the circulation of cooled air while precluding the passage of goods, e.g. the contents of the lid compartment, from falling into the main compartment. In the illustrated embodiment, the perforated wall 46 comprises the inner or bottom wall of the lid compartment so that wall 46 generally corresponds in size to the lid compartment, to maximize the exposure of the interior 40 of the lid compartment to the cooling effects of the main compartment. It is to be understood, however, that the opening 44 and the perforate wall 46 may be smaller than the respective wall of the auxiliary compartment.

In the illustrated embodiment, where the cooler is provided as a soft side cooler, the perforated wall 46 is preferably provided by a fabric mesh that is stitched to the flexible cooler wall. For a rigid or hard sided cooler, the perforated wall may be glued, welded, and/or fastened in place with mechanical fasteners so as to allow air but not goods to pass from one compartment to the next. In the alternative, the lid of the container may be molded to define a rigid but perforated or sieve-like wall between the respective compartments. An advantage of a flexible mesh wall, however, is that an overlapped, partial double wall structure may be provided so that, if necessary or desirable, the dry goods storage compartment can be accessed from the interior surface of the lid 22 as well as through the lid compartment 30. In this manner, the dry goods can be accessed when the lid 22 is in its open position, if necessary or desirable.

As a further illustration of the principles of the invention, a secondary or auxiliary compartment 32 is also illustrated on one of the side walls, for example, the front wall of the cooler. In the illustrated embodiment, the side compartment is defined by a top wall 48, a bottom wall 50, a outer or peripheral side wall 52 and an inner wall common with the respective side wall of the main compartment 24. As illustrated in FIG. 4, an opening 54 closed by a perforated wall 56 is defined between the side compartment and the main compartment 24. As illustrated, the perforated wall 56 between the side and main compartments terminates above the bottom of the main compartment, so that any water from melted ice within the main compartment will advantageously remain within the main compartment and not pass into the side compartment.

Furthermore, in the illustrated embodiment, beverage container openings 34 are defined in the top wall 48 of the side compartment 32. The beverage receptacles may include flexible downwardly depending holders for the beverage containers or may simply be openings in the top wall of the side compartment 32 so that the beverage containers are placed fully into the side compartment and rest on the bottom wall 50 of the side compartment. As will be appreciated, the perforated wall 56, which may be, e.g., a mesh fabric wall or a rigid sieve like wall, allows the cooled air from the main compartment to circulate into the side compartment and keep the contents thereof at a temperature lower than ambient temperature. Likewise, any beverage containers received through the beverage container openings 34 of the side compartment will likewise be cooled or kept cool by the circulating cooled air.

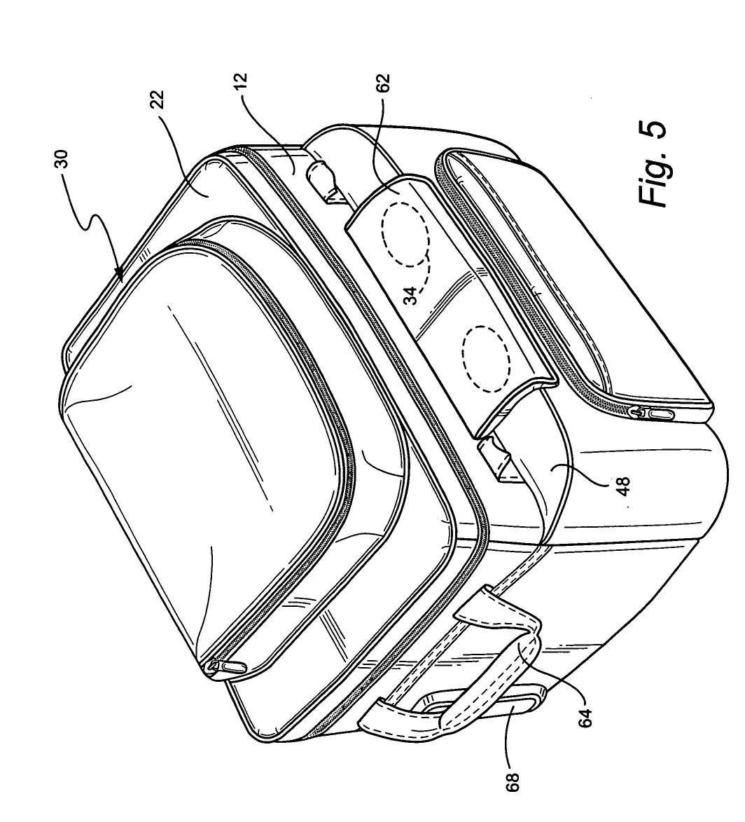

In the illustrated embodiment an access opening with access door 60 is provided on the side auxiliary compartment to provide selective access to its interior for retrieval of goods without compromising the retained cooled air of the main compartment of the cooler. As illustrated in FIG. 5, if deemed necessary or desirable, a closure cover 62, such as a pivoting lid, may be provided for the beverage container openings 34, to selectively close the beverage container openings when not in use. As will be appreciated, closure cover will prevent substantial cooling loss through beverage container openings 34. When it is desired to place a beverage in a beverage opening of the side compartment, the closure cover lid may be pivoted to its open position (not shown) and the beverage container placed in its respective opening to be maintained in a convenient location and at a reduced temperature.

Other accessories and components may be included on the cooler as illustrated, such as carrying handles 64, 66 and additional storage compartments 68, 70, which may or may not be in communication with the main storage compartment of the cooler.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An insulated cooler comprising:
a plurality of insulating side wall panels, a bottom wall panel and a lid panel, said wall panels defining together with said lid panel an insulated main compartment;
an auxiliary storage compartment provided in or on one of said lid and side wall panels, said auxiliary compartment including an outer peripheral wall and an inner wall that is common with said respective one of said lid and side wall panels, wherein at least a portion of said inner wall has at least one hole defined therethrough to allow air to flow between said main compartment and an interior of said auxiliary compartment while preventing the contents of the auxiliary compartment from entering the main compartment; and
at least one access door for selectively accessing said auxiliary compartment remote from said main compartment.

2. An insulated cooler as in claim 1, wherein the portion of said inner wall having said at least one hole comprises a perforated wall portion.

3. An insulated cooler as in claim 2, wherein the perforated wall portion comprises a flexible mesh wall.

4. An insulated cooler as in claim 1, wherein the cooler is soft-sided comprising flexible top and side wall panels

5. An insulated cooler as in claim 1, further comprising a mechanical fastener for selectively securing said access door in a closed position.

6. An insulated cooler as in claim 6, wherein said mechanical fastener is a zipper.

7. An insulated cooler as in claim 1, wherein said outer peripheral wall is comprised of a peripheral side wall and an outer wall defining said access door.

8. An insulated cooler as in claim 1, wherein the auxiliary compartment is defined on one of said side wall panels and wherein said outer peripheral wall comprises a top wall, a bottom wall and a peripheral outer side wall and further comprising at least one beverage container opening defined in said top wall.

9. An insulated cooler as in claim 8, further comprising a beverage container receptacle depending downwardly from said beverage container opening for receiving and supporting a beverage container inserted through said beverage container opening.

10. An insulated cooler as in claim 8, further comprising a closure cover for selectively covering said at least one beverage container opening.

11. A soft-sided cooler comprising:
a plurality of insulating side wall panels, a bottom wall panel and a lid panel, said wall panels defining together with said lid panel an insulated main compartment; an auxiliary storage compartment provided in or on one of said lid and side wall panels, said auxiliary compartment including an outer peripheral wall and an inner wall that is common with said respective one of said lid and side wall panels,
wherein at least a portion of said inner wall has at least one hole defined therethrough to allow air to flow between said main compartment and an interior of said auxiliary compartment while preventing the contents of the auxiliary compartment from entering the main compartment, and
wherein said side walls are flexible, insulated walls comprising a flexible liner layer, a flexible outer layer, and an insulation layer therebetween.

12. A soft-sided cooler as in claim 11, wherein the portion of said inner wall having said at least one hole is defined by an opening in said inner wall that is closed by a perforated wall.

13. A soft-sided cooler as in claim 12, wherein the perforated wall comprises a flexible mesh wall.

14. A soft-sided cooler as in claim 12, wherein said auxiliary compartment is disposed in or on a said side wall and wherein said perforated wall is smaller than said inner wall and is spaced from said bottom wall of said main compartment.

15. A soft-sided cooler as in claim 11, further comprising at least one access door for selectively accessing said auxiliary compartment remote from said main compartment, and a mechanical fastener for selectively securing said access door in a closed position.

16. A soft-sided cooler as in claim 15, wherein said mechanical fastener is a zipper.

17. A soft-sided cooler as in claim 11, wherein said outer peripheral wall is comprised of a peripheral side wall and an outer wall defining an access lid for said auxiliary compartment.

18. A soft-sided cooler as in claim 1, wherein the auxiliary compartment is defined on one of said side wall panels and wherein said outer peripheral wall comprises a top wall, a bottom wall and a peripheral outer side wall and further comprising at least one beverage container opening defined in said top wall.

19. A soft-sided cooler as in claim 18, further comprising a beverage container receptacle depending downwardly from said beverage container opening for receiving and supporting a beverage container inserted through said beverage container opening.

20. A soft-sided cooler as in claim 18, further comprising a closure cover for selectively covering said at least one beverage container opening.
